(19) United States
(12) Patent Application Publication
(10) Pub. No.: US 2017/0174871 A1
(43) Pub. Date: Jun. 22, 2017

(54) RESIN COMPOSITION AND RESIN MOLDED ARTICLE

(71) Applicant: FUJI XEROX CO., LTD., Tokyo (JP)

(72) Inventor: Kenji YAO, Kanagawa (JP)

(73) Assignee: FUJI XEROX CO., LTD., Tokyo (JP)

(21) Appl. No.: 15/097,779

(22) Filed: Apr. 13, 2016

(30) Foreign Application Priority Data
Dec. 21, 2015 (JP) 2015-248603

(51) Int. Cl. C08L 1/12; C08K 5/11; C08K 5/00

(52) U.S. Cl. CPC C08L 1/12; C08K 5/0016; C08K 5/11; C08L 2207/04

(57) ABSTRACT

A resin composition includes 100 parts by weight of a cellulose derivative in which at least one hydroxyl group of cellulose is substituted with an acetyl group; and from 5 parts by weight to 20 parts by weight of a non-reactive plasticizer which does not have a functional group capable of reacting with the cellulose derivative, wherein a notched impact test piece formed from the resin composition by a method according to ISO179 exhibits a notched Charpy impact strength as measured at 23° C. by the method according to ISO179, of 11 kJ/m² or more.

### CROSS-REFERENCE TO RELATED APPLICATIONS

This application is based on and claims priority under 35 USC 119 from Japanese Patent Application No. 2015-248603 filed Dec. 21, 2015.

### BACKGROUND

1. Technical Field

The invention relates to a resin composition and a resin molded article.

2. Related Art

In the related art, various resin compositions are offered and used in various applications. In particular, resin compositions are used for household appliances, various parts of automobiles, housings, and the like. Meanwhile, thermoplastic resins are used even in parts such as housings of office equipment and electronic and electric equipment.

In recent years, plant-derived resins have been used, and there is a cellulose derivative as one of the plant-derived resins which have been well known in the art.

### SUMMARY

According to an aspect of the invention, there is provided a resin composition, including:

100 parts by weight of a cellulose derivative in which at least one hydroxyl group of cellulose is substituted with an acetyl group; and

from 5 parts by weight to 20 parts by weight of a non-reactive plasticizer which does not have a functional group capable of reacting with the cellulose derivative,

wherein a notched impact test piece formed from the resin composition by a method according to ISO179 exhibits a notched Charpy impact strength, as measured at 23° C. by the method according to ISO179, of 11 kJ/m² or more.

### DETAILED DESCRIPTION

Hereinafter, a resin composition and a resin molded article according to an exemplary embodiment of the invention will be described.

Resin Composition

The resin composition according to the exemplary embodiment includes: 100 parts by weight of a cellulose derivative (hereinafter, referred to as “acetylcellulose derivative”) in which at least one hydroxyl group is substituted with an acetyl group; and 5 parts by weight to 20 parts by weight of a non-reactive plasticizer (hereinafter, simply referred to as “plasticizer”) which does not have a functional group capable of reacting with the cellulose derivative.

The resin composition is formed into a notched impact test piece by a method according to ISO179, and the notched Charpy impact strength of the notched impact test piece, which is measured at 23° C. by the method according to ISO179, is 11 kJ/m² or more.

In the following description, the notched Charpy impact strength of the notched impact test piece formed by the method according to ISO179, which is measured at 23° C. by the method according to ISO179, is simply referred to as “Charpy impact strength”.

According to the resin composition of the exemplary embodiment, by having the above configuration, a resin molded article having improved tensile strength and tensile elastic modulus may be obtained. The reason for this is not clear, but is supposed as follows.

In the related art, it has been known to obtain a resin molded article using a resin composition containing a cellulose derivative, such as acetylcellulose, and a plasticizer. However, in the resin composition containing a cellulose derivative and a plasticizer, the plasticizer is mainly used to compensate for the shortage of flexibility of the cellulose derivative. The flexibility of the resin molded article formed using the resin composition containing the cellulose derivative and the plasticizer is improved, but the tensile strength (maximum tensile strength) and tensile elastic modulus thereof are liable to be decreased, compared to those of the resin molded article formed using only the cellulose derivative. Therefore, the resin molded article formed using the resin composition containing the cellulose derivative and the plasticizer have been required to improve tensile strength and tensile elastic modulus.

In the resin composition containing a cellulose derivative and a plasticizer, the distance between cellulose derivative molecules is increased by the plasticizer, and thus the flexibility of the resin composition is improved. In addition, with the increase in the content of the plasticizer, the flexibility of the resin composition is increased to be easily deformed, and thus the Charpy impact strength of the obtained resin molded article is improved. However, the tensile strength and tensile elastic modulus of the resin molded article are liable to be deteriorate due to the increase in the flexibility of the resin composition.

Meanwhile, in the resin molded article obtained by molding a resin composition not containing a plasticizer or containing a very small amount of a plasticizer, the tensile strength of this resin molded article is increased by the hydrogen bond of the cellulose derivative. However, if the tensile strength thereof becomes excessively high, the resin molded article is difficult to be deformed, and thus this resin molded article tends to become hard and fragile. In addition, if the content of the plasticizer is too small, the fluidity of the resin composition is excessively decreased, so that the moldability of the resin composition is decreased, and thus it is difficult to obtain the resin molded article in some cases.

In contrast, in the resin composition according to the exemplary embodiment, when the Charpy impact strength of the resin molded article formed using the resin composition is 11 kJ/m² or more, the tensile strength and tensile elastic modulus of the resin molded article is improved.

The cellulose derivative and the plasticizer have properties difficult to dissolve each other. Therefore, the plasticizer is present in a state of being dispersed in the resin composition. In this case, if the diameter of the plasticizer dispersed in the resin composition becomes small, it is considered that the distance between the cellulose derivative molecules, which is to be increased by the plasticizer, becomes short. In addition, if the resin molded article is formed using a resin composition in which the diameter of the plasticizer dispersed is small, it is considered that the Charpy impact strength of this resin molded article becomes 11 kJ/m² or more, and the deterioration of the tensile strength and tensile elastic modulus thereof is easily prevented. As a result, it is considered that the tensile strength and tensile elastic modulus of the obtained resin molded article is improved compared to those of a conventional resin molded article formed using a resin composition containing a cellulose derivative and a plasticizer.

From the above, since the resin composition according to the exemplary embodiment has the above configuration, it is supposed that a resin molded article having improved tensile strength and tensile elastic modulus is obtained.

Hereinafter, components of the resin composition according to the exemplary embodiment will be described in detail.

Acetylcellulose Derivative

The resin composition according to the exemplary embodiment includes an acetylcellulose derivative.

Here, as the cellulose derivative, a cellulose derivative, in which at least one hydroxyl group of cellulose is substituted with a substituent such as an acetyl group, a propionyl group, or the like, is known.

However, in the case where at least one hydroxyl group of cellulose is substituted with a substituent having a large number of carbon atoms, such as a propionyl group, the thermal fluidity of the cellulose derivative substituted with a substituent having a large number of carbon atoms becomes too high. Therefore, in the case where a resin molded article is formed using the resin composition including the cellulose derivative substituted with a substituent having a large number of carbon atoms, the flexibility of the resin molded article is improved and thus the Charpy impact strength of the resin molded article is easily improved, but the tensile strength and tensile elastic modulus thereof are liable to be deteriorated. Meanwhile, in the case where the hydroxyl group of cellulose is unsubstituted, thermal melting molding (particularly, injection molding) is liable to become difficult.

Therefore, in the resin composition according to the exemplary embodiment, a cellulose derivative, in which at least one hydroxyl group of cellulose is substituted with an acetyl group, is used.

The acetyl cellulose derivative is a cellulose derivative in which at least one hydroxyl group of cellulose is substituted with an acetyl group, and, specifically, is preferably a compound represented by the formula (1) below.

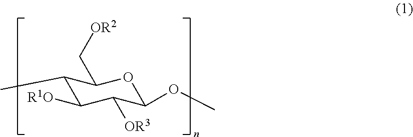

In the formula (1), R¹, R², and R³ each independently represents a hydrogen atom or an acetyl group. n represents an integer of 2 or more; provided that at least one of n R¹s, n R²s, and n R³s represents an acetyl group.

In the formula (1), the range of n is not particularly limited, but may be determined in accordance with the preferable range of a weight average molecular weight. Specifically, the range of n may be 200 to 1,000, preferably 250 to 850, and more preferably 300 to 750.

When n is set to 200 or more, the strength of the resin molded article easily becomes high. When n is set to 1,000 or less, the deterioration of the flexibility of the resin molded article is easily prevented.

Weight Average Molecular Weight

The weight average molecular weight of the acetylcellulose derivative maybe appropriately 40, 000 or more, preferably 50,000 or more, and more preferably 60,000 or more. The upper limit thereof may be appropriately 300,000 or less, and preferably 200,000 or less.

When the weight average molecular weight thereof is within the above range, the Charpy impact strength of the obtained resin molded article is easily controlled to 11 kJ/m², and the tensile strength and tensile elastic modulus thereof is easily improved.

The weight average molecular weight (Mw) is a value measured by gel permeation chromatography (GPC). Specifically, the molecular weight measurement by GPC is performed using a solution of dimethylacetamide/lithium chloride having a volume ratio of 90/10 by a GPC apparatus (manufactured by Tosoh Corporation, HLC-8320GPC, Column: TSKgelα-M).

Substitution Degree

The substitution degree of the acetylcellulose derivative is preferably 2.1 to 2.6, and more preferably 2.2 to 2.5, in terms of increasing thermal fluidity.

When the substitution degree thereof is within the above range of 2.1 to 2.6, the deterioration in thermoplasticity of the acetylcellulose derivative is easily prevented. Further, the occurrence of intermolecular packing in the obtained resin molded article is easily prevented. As a result, the deterioration in the tensile strength and tensile elastic modulus of the resin molded article is easily prevented.

Here, the substitution degree refers to an index for showing a degree in which hydroxyl groups of acetylcellulose are substituted with a substituent. In other words, the substitution degree is an index for showing a degree of acetylation of the acetylcellulose derivative. Specifically, the substitution degree means an intramolecular average of the number of substituents for three hydroxyl groups in the D-glucopyranose unit of the acetylcellulose derivative which is substituted with an acetyl group.

The substitution degree is determined from the integration ratio of a cellulose-derived hydrogen and an acetyl group-derived peak by H¹-NMR (JNM-ECA series, manufactured by JEOL RESONANCE Co., Ltd.).

Specific examples of the acetylcellulose derivative are shown as follows, but are not limited thereto.

| | Name of | Name of | | | Weight average | Substitution |
|---|---|---|---|---|---|---|
| | compound | product | Manufacturer | Substituents R¹, R², R³ | molecular weight | degree |
| CE1 | Diacetyl | L-50 | Daicel | Hydrogen atom or | 161,000 | 2.41 |
| | cellulose | | | acetyl group | | |
| CE2 | Diacetyl | L-20 | Daicel | Hydrogen atom or | 119,000 | 2.41 |
| | cellulose | | | acetyl group | | |
| CE3 | Diacetyl | CA-389-3 | Eastman | Hydrogen atom or | 79,500 | 2.12 |
| | cellulose | | Chemical | acetyl group | | |
| CE4 | Triacetyl | LT-55 | Daicel | Hydrogen atom or | 198,000 | 2.91 |
| | cellulose | | | acetyl group | | |

Plasticizer

In the exemplary embodiment, the “non-reactivity” of the non-reactive plasticizer means that the plasticizer does not have a functional group capable of reacting with the acetylcellulose derivative.

The non-reactive plasticizer is not particularly limited as long as it does not have a functional group capable of reacting with the acetylcellulose derivative. Examples of the non-reactive plasticizer include compounds having an ester group, and specific examples thereof include a polyether ester compound and a compound containing an adipic acid ester (hereinafter, also referred to as a “adipic acid ester-containing compound). Among these, an adipic acid ester-containing compound is preferable in that the bleeding of the plasticizer (precipitation phenomenon to the surface) is easily prevented.

Adipic Acid Ester-Containing Compound

An adipic acid ester-containing compound refers to a compound of adipic acid ester alone, and a mixture of an adipic acid ester and a component other than the adipic acid ester (compound different from adipic acid ester). However, the adipic acid ester-containing compound may preferably contain the adipic acid ester in an amount of 50% by weight or more with respect to the total amount of the adipic acid ester and the other components.

As the adipic acid ester, for example, an adipic acid diester, and an adipic acid polyester are exemplified. Specifically, an adipic acid diester represented by the formula (2-1) and an adipic acid polyester represented by the formula (2-2) are exemplified.

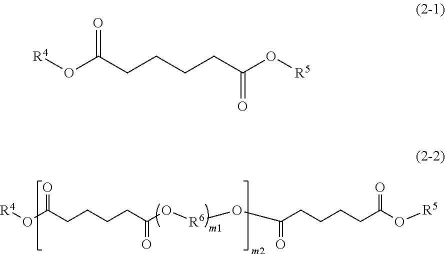

In the formulae (2-1) and (2-2), R⁴ and R⁵ each independently represents an alkyl group, or a polyoxyalkyl group [—(CₓH₂ₓ—O)_{y}—R^{A1}] (where R^{A1} represents an alkyl group, x represents an integer in the range of 1 to 6, and y represents an integer in the range of 1 to 6).

R⁶ represents an alkylene group.

m1 represents an integer in the range of 1 to 5.

m2 represents an integer in the range of 1 to 10.

In the formulae (2-1) and (2-2), the alkyl groups represented by R⁴ and R⁵ are preferably alkyl groups having 1 to 6 carbon atoms, and more preferably alkyl groups having 2 to 4 carbon atoms. The alkyl groups represented by R⁴ and R⁵ may have any one of a linear shape, a branched shape, or a cyclic shape, but preferably a linear shape and a branched shape.

In the formulae (2-1) and (2-2), in the polyoxyalkyl group represented by R⁴ and R⁵ [—CₓH₂ₓ—O)_{y}—R^{A1}], the alkyl group represented by R^{A1} is preferably an alkyl group having 1 to 6 carbon atoms, and more preferably an alkyl group having 2 to 4 carbon atoms. The alkyl group represented by R^{A1} may have any one of a linear shape, a branched shape, or a cyclic shape, but preferably a linear shape and a branched shape.

x represents an integer in the range of 1 to 6, and y represents an integer in the range of 1 to 6.

In the formulae (2-1) and (2-2), the alkylene group represented by R⁶ is preferably an alkylene group having 1 to 6 carbon atoms, and more preferably an alkylene group having 2 to 4 carbon atoms. The alkylene group represented by R⁶ may have any one of a linear shape, a branched shape, or a cyclic shape, but preferably a linear shape and a branched shape.

In the formulae (2-1) and (2-2), the group represented by each of R⁴ to R⁶ may be substituted with a substituent. As the substituent, an alkyl group, an aryl group, and an acyl group are exemplified.

The molecular weight of the adipic acid ester (or weight average molecular weight) is preferably in the range of 100 to 10,000, and more preferably in the range of 200 to 3,000. The weight average molecular weight is a value measured according to the method of measuring the weight average molecular weight of the cellulose derivative described above.

Specific examples of the adipic acid ester-containing compound are described below, but not limited thereto.

| | Name of Material | Name of Product | Manufacturer |
|---|---|---|---|
| ADP1 | Adipic acid diester | Daifatty 101 | Daihachi Chemical |
| | | | Industry Co., Ltd. |
| ADP2 | Adipic acid diester | Adeka Cizer RS-107 | ADEKA Corporation |
| ADP3 | Adipic acid polyester | Polycizer W-230-H | DIC Corporation |
| ADP4 | Adipic acid diester | Daifatty 121 | Daihachi Chemical |
| | | | Industry Co., Ltd. |
| ADP5 | Adipic acid diester | Daifatty 110 | Daihachi Chemical |
| | | | Industry Co., Ltd. |

Polyether Ester Compound

As the polyether ester compound, for example, a polyether ester compound represented by the formula (2-3) is exemplified.

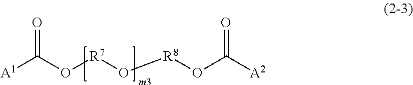

In the formula (2-3), R⁷ and R⁸ each independently represents an alkylene group having 2 to 10 carbon atoms. A¹ and A² each independently represents an alkyl group having 1 to 6 carbon atoms, an aryl group having 6 to 12 carbon atoms, or an aralkyl group having 7 to 18 carbon atoms. m3 represents an integer of 1 or greater.

In the formula (2-3), as the alkylene group represented by R⁷, an alkylene group having 3 to 10 carbon atoms is preferable, and an alkylene group having 3 to 6 carbon atoms is more preferable. The alkylene group represented by R⁷ may have any one of a linear shape, a branched shape, or a cyclic shape, but preferably a linear shape.

If the number of carbons of the alkylene group represented by R⁷ is 3 or greater, the decrease of the fluidity of the resin composition is prevented, and thermoplasticity is easily exhibited. If the number of carbons of the alkylene group represented by R⁷ is 10 or lower, or if the alkylene group represented by R⁷ has a linear shape, the affinity to the acetylcellulose derivative is easily enhanced.

In this point of view, particularly, the alkylene group represented by R⁷ is preferably a n-hexylene group (—(CH₂)₆—). That is, the polyether ester compound is preferably a compound where R⁷ represents a n-hexylene group (—(CH₂)₆—).

In the formula (2-3), as the alkylene group represented by R⁸, an alkylene group having 3 to 10 carbon atoms is preferable, and an alkylene group having 3 to 6 carbon atoms is more preferable. The alkylene group represented by R⁸ may have any one of a linear shape, a branched shape, or a cyclic shape, but preferably a linear shape.

If the number of carbons of the alkylene group represented by R⁸ is 3 or greater, the decrease of the fluidity of the resin composition is prevented, and the thermoplasticity is easily exhibited. If the number of carbons of the alkylene group represented by R⁸ is 10 or lower, or if the alkylene group represented by R⁸ has a linear shape, the affinity to the acetylcellulose derivative is easily enhanced.

In this point of view, particularly, the alkylene group represented by R⁸ is preferably a n-butylene group (—(CH₂)₄—). That is, the polyether ester compound is preferably a compound where R⁸ represents a n-butylene group (—(CH₂)₄—).

In the formula (2-3), the alkyl groups represented by A¹ and A² are preferably alkyl groups having 1 to 6 carbon atoms, and alkyl groups having 2 to 4 carbon atoms are more preferable. The alkyl groups represented by A¹ and A² may have any one of a linear shape, a branched shape, or a cyclic shape, but preferably a branched shape.

As examples of the aryl groups represented by A¹ and A², an unsubstituted aryl group such as a phenyl group and a naphthyl group and a substituted phenyl group such as a methylphenyl group and a t-butylphenyl group are exemplified.

The aralkyl group represented by A¹ and A² is a group represented by —R^{A}-Ph. R^{A} represents a linear-shaped or branched alkylene group having 1 to 6 carbon atoms (preferably, having 2 to 4 carbon atoms). Ph represents an unsubstituted phenyl group or a substituted phenyl group which is substituted with the linear-shaped or branched alkyl group having 1 to 6 carbon atoms (preferably, having 2 to 4 carbon atoms). As the aralkyl group, specifically, for example, an unsubstituted aralkyl group such as a benzyl group, a phenylmethyl group (phenethyl group), a phenylpropyl group, and a phenylbutyl group, and a substituted aralkyl group such as a methylbenzyl group, a dimethylbenzyl group, and a methylphenethyl group are exemplified.

At least one of A¹ and A² preferably represents an aryl group or an aralkyl group. That is, the polyether ester compound is preferably a compound where at least one of A¹ and A² represents an aryl group (preferably, phenyl group) or an aralkyl group, and preferably a compound where both of A¹ and A² represent an aryl group (preferably, phenyl group) or an aralkyl group, particularly, an aryl group (preferably, phenyl group). The polyether ester compound where at least one of A¹ and A² represents an aryl group (preferably, phenyl group) or an aralkyl group easily form an appropriate space between molecules of the acetylcellulose derivative, and thereby further prevent crystallization of celluloses and improve moldability of the resin composition.

In the formula (2-3), the range of m3 is not particularly limited, but, preferably from 1 to 5, more preferably from 1 to 3.

If m3 is 1 or more, bleeding (deposition) of the polyether ester compound becomes difficult. If m3 is 5 or less, the affinity to the acetylcellulose derivative is easily enhanced.

Subsequently, characteristics of the polyether ester compound are described.

The weight average molecular weight (Mw) of the polyether ester compound is preferably in the range of 450 to 650, and more preferably in the range of 500 to 600.

If the weight average molecular weight (Mw) is 450 or greater, bleeding (phenomenon of deposition) becomes difficult. If the weight average molecular weight (Mw) is 650 or lower, the affinity to the acetylcellulose derivative resin is easily enhanced.

In addition, the weight average molecular weight (Mw) of the polyether ester compound is a value measured by gel permeation chromatography (GPC). Specifically, the measurement of the molecular weight by GPC is performed by using HPLC1100 manufactured by Tosoh Corporation as a measurement apparatus, and TSKgel GMHHR-M+TSKgel GMHHR-M (7.8 mm I.D. 30 cm) which is a column manufactured by Tosoh Corporation, with a chloroform solvent. Also, the weight average molecular weight is calculated by using a molecular weight calibration curve obtained by a monodispersed polystyrene standard sample from the measurement result.

The viscosity of the polyether ester compound at 25° C. is preferably in the range of 35 mPa·s to 50 mPa·s, and more preferably in the range of 40 mPa·s to 45 mPa·s.

If the viscosity is 35 mPa·s or greater, the dispersibility to the acetylcellulose derivative is easily enhanced. If the viscosity is 50 mPa·s or lower, anisotropy of the dispersion of the polyether ester compound hardly appears.

In addition, the viscosity is a value measured by a Brookfield B-type viscosmeter.

The Hazen color number (APHA) of the polyether ester compound is preferably 100 to 140, and more preferably 100 to 120.

If the Hazen color number (APHA) is 100 or more, the difference in refractive index between the polyether ester compound and the acetylcellulose derivative is reduced, and a phenomenon of the resin molded article becoming cloudy hardly occurs. If the Hazen color number (APHA) is 140 or less, the resin molded article hardly takes on a yellow tinge. Therefore, if the Hazen color number (APHA) is within the above range, the transparency of the resin molded article is improved.

The Hazen color number (APHA) is a value measured according to JIS-K0071 (1998).

The solubility parameter (SP value) of the polyether ester compound is preferably 9 to 11, and more preferably 9.5 to 10.

If the solubility parameter (SP value) is 9 to 11, the dispersibiity to the acetylcellulose derivative is easily improved.

The solubility parameter (SP value) is a value calculated by the method of Fedor. Specifically, the solubility parameter (SP value) is calculated by the following Equation according to the description of Polym. Eng. Sci., vol. 14, p. 147 (1974).

SP value=√(Ev/v)=√(ΣΔei/ΣΔvi) Equation:

(In the Equation, Ev: evaporation energy (cal/mol), v: molar volume (cm³/mol), Δei: evaporation energy each atom or atomic group, Δvi: molar volume of each atom or atomic group)

In addition, solubility parameter (SP value) adopts (cal/cm³) ^{1/2} as a unit, but may omit the unit in accordance with practice to be represented in a non-dimensional manner.

Here, particularly, the polyether ester compound is preferably a compound in which R⁸ represents a n-butylene group, at least one of A¹ and A² represents an aryl group or an aralkyl group, and weight average molecular weight (Mw) is 450 to 650.

In addition, from the same point of view, the polyether ester compound is preferably a compound in which viscosity at 25° C. is 35 mPa·s to 50 mPa·s, Hazen color number (APHA) is 100 to 140, and solubility parameter (SP value) is 9 to 11.

Hereinafter, specific examples of the polyether ester compound are described, but not limited thereto.

| | | | | | | Viscosity | | SP |
|---|---|---|---|---|---|---|---|---|
| | R⁷ | R⁸ | A¹ | A² | Mw | (25° C.) | APHA | value |
| PEE1 | —(CH₂)₆— | —(CH₂)₄— | Phenyl group | Phenyl group | 550 | 43 | 120 | 9.7 |
| PEE2 | —(CH₂)₂— | —(CH₂)₄— | Phenyl group | Phenyl group | 570 | 44 | 115 | 9.4 |
| PEE3 | —(CH₂)₁₀— | —(CH₂)₄— | Phenyl group | Phenyl group | 520 | 48 | 110 | 10.0 |
| PEE4 | —(CH₂)₆— | —(CH₂)₂— | Phenyl group | Phenyl group | 550 | 43 | 115 | 9.3 |
| PEE5 | —(CH₂)₆— | —(CH₂)₁₀— | Phenyl group | Phenyl group | 540 | 45 | 115 | 10.1 |
| PEE6 | —(CH₂)₆— | —(CH₂)₄— | t-Butyl group | t-Butyl group | 520 | 44 | 130 | 9.7 |
| PEE7 | —(CH₂)₆— | —(CH₂)₄— | Phenyl group | Phenyl group | 460 | 45 | 125 | 9.7 |
| PEE8 | —(CH₂)₆— | —(CH₂)₄— | Phenyl group | Phenyl group | 630 | 40 | 120 | 9.7 |
| PEE9 | —(CH₂)₆— | —(CH₂)₄— | Phenyl group | Phenyl group | 420 | 43 | 135 | 9.7 |
| PEE10 | —(CH₂)₆— | —(CH₂)₄— | Phenyl group | Phenyl group | 670 | 48 | 105 | 9.7 |
| PEE11 | —(CH₂)₆— | —(CH₂)₄— | Phenyl group | Phenyl group | 550 | 35 | 130 | 9.7 |
| PEE12 | —(CH₂)₆— | —(CH₂)₄— | Phenyl group | Phenyl group | 550 | 49 | 125 | 9.7 |
| PEE13 | —(CH₂)₆— | —(CH₂)₄— | Phenyl group | Phenyl group | 550 | 32 | 120 | 9.7 |
| PEE14 | —(CH₂)₆— | —(CH₂)₄— | Phenyl group | Phenyl group | 550 | 53 | 105 | 9.7 |
| PEE15 | —(CH₂)₆— | —(CH₂)₄— | Phenyl group | Phenyl group | 550 | 43 | 135 | 9.7 |
| PEE16 | —(CH₂)₆— | —(CH₂)₄— | Phenyl group | Phenyl group | 550 | 43 | 105 | 9.7 |
| PEE17 | —(CH₂)₆— | —(CH₂)₄— | Phenyl group | Phenyl group | 550 | 43 | 150 | 9.7 |
| PEE18 | —(CH₂)₆— | —(CH₂)₄— | Phenyl group | Phenyl group | 550 | 43 | 95 | 9.7 |

Polyolefin-Containing Multifunctional Elastomer

The resin composition according to the exemplary embodiment may further include a polyolefin-containing multifunctional elastomer containing a polyolefin, in which olefin monomers are polymerized, as a main component and a functional group having at least one selected from an epoxy group and a glycidyl group. Here, the “containing a polyolefin, in which olefin monomers are polymerized, as a main component” means that the polyolefin is polymerized using 50% by weight or more of olefin monomers with respect to the total monomer components.

Specific examples of the polyolefin-containing multifunctional elastomer include polyolefin-glycidyl methacrylate copolymers in which olefin monomers are polymerized. Specific examples thereof include ethylene-glycidyl methacrylate copolymers, ethylene-vinyl acetate-glycidyl methacrylate copolymers, ethylene-acrylic acid methyl ester-glycidyl methacrylate copolymers, ethylene-acrylic acid ethyl ester-glycidyl methacrylate copolymers, ethylene-acrylic acid butyl ester-glycidyl methacrylate copolymers, ethylene-acrylic acid-acrylic acid ester-glycidyl methacrylate copolymers, ethylene-methacrylic acid ester-glycidyl methacrylate copolymers, copolymers in each of which an ethylene-methacrylic acid-methacrylic acid ester copolymer is graft-polymerized with glycidyl methacrylate, copolymers in each of which an ethylene-propylene copolymer is graft-polymerized with glycidyl methacrylate, copolymers in each of which an ethylene-propylene-diene copolymer is graft-polymerized with glycidyl methacrylate, copolymers in each of which an ethylene-a-olefin copolymer is graft-polymerized with glycidyl methacrylate, copolymers in each of which an ethylene-vinyl acetate copolymer is graft-polymerized with glycidyl methacrylate, propylene-glycidyl methacrylate copolymers, and propylene-glycidyl methacrylate graft copolymers.

The polyolefin-containing multifunctional elastomer is more preferably a compound represented by the formula (3) below. If the compound represented by the formula (3) below is used, the acetyl group or hydroxyl group of the acetylcellulose derivative easily reacts with an epoxy group or a glycidyl group. Since the distance between the acetylcellulose derivatives is increased by a bond caused by this reaction, the fluidity of the resin composition is easily improved. Further, in the resin molded article after molding, a bonding portion is compressed by pressure keeping, and the space between molecules of the acetylcellulose derivative tends to be densely packed. As a result, tensile strength and tensile elastic modulus are easily improved.

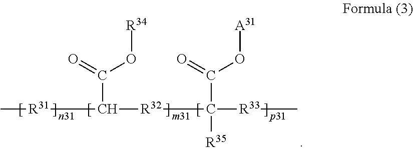

In the formula (3), R³¹ represents a linear alkylene group having 2 to 6 carbon atoms.

R³² and R³³ each independently represents a linear alkylene group having 1 to 6 carbon atoms.

R³⁴ and R³⁵ each independently represents a linear or branched alkyl group having 1 to 4 carbon atoms.

A³¹ represents an epoxy group or a glycidyl group.

n31 represents a integer of 50 to 100, and

m31 and p31 each independently represents an integer of 1 to 50.

In the formula (3), the linear alkylene group having 2 to 6 carbon atoms represented by R³¹ is preferably an alkylene group having 2 to 4 carbon atoms, more preferably an alkylene group having 2 or 3 carbon atoms, and further preferably an alkylene group having 2 carbon atoms (ethylene group (—CH₂CH₂−)).

In the formula (3), the linear alkylene group having 1 to 6 carbon atoms represented by each of R³² and R³³ is preferably an alkylene group having 1 to 4 carbon atoms, more preferably an alkylene group having 1 to 3 carbon atoms, and further preferably an alkylene group having 1 carbon atom (methylene group (—CH₂—)).

In the formula (3), the linear or branched alkyl group having 1 to 4 carbon atoms represented by each of R³⁴ and R³⁵ is preferably a linear or branched alkyl group having 1 to 3 carbon atoms, more preferably a linear alkyl group having 1 or 2 carbon atoms, and further preferably an alkyl group having 1 carbon atom (methyl group (—CH₃)).

In the formula (3), the group represented by A³¹ may be any of an epoxy group or a glycidyl group, but is preferably a glycidyl group.

In the formula (3), the integer represented by n31 is preferably 55 to 100, and more preferably 60 to 100.

The integer represented by m31 is preferably 1 to 40, and more preferably 1 to 30.

The integer represented by p31 is preferably 1 to 40, and more preferably 1 to 30.

In terms of improving the tensile strength and tensile elastic modulus of the resin molded article, the compound represented by the formula (3) is preferably a compound in which R³¹ is an ethylene group, each of R³² and R³³ is a methylene group, each of R³⁴ and R³⁵ is a methyl group, and A³¹ is a glycidyl group.

Specific examples of the polyolefin-containing multifunctional elastomer represented by the formula (3) are shown as follows, but are not limited thereto.

In addition, E-MA-GMA represents an ethylene-methylacrylate-glycidylmethacrylate copolymer.

| | Name of material | Name of product | Manufacturer |
|---|---|---|---|
| 1 | E-MA-GMA | LOTADER AX8900 | ARKEMA Corporation |
| 2 | E-MA-GMA | BONDFAST 7M | Sumitomo Chemical, |
| | | | Co., Ltd. |
| 3 | E-MA-GMA | BONDFAST 7L | Sumitomo Chemical, |
| | | | Co., Ltd. |

Composition of Resin Composition

Contents of Acetylcellulose Derivative and Plasticizer

The resin composition according to the exemplary embodiment includes an acetylcellulose derivative in an amount of 100 parts by weight, and includes a plasticizer in an amount of 5 parts by weight to 20 parts by weight. That is, the content of the plasticizer is 5 parts by weight to 20 parts by weight with respect to 100 parts by weight of the acetylcellulose derivative. In terms of further improving the tensile strength and tensile elastic modulus of the resin molded article, the content of the plasticizer is preferably 5 parts by weight to 18 parts by weight, more preferably 5 parts by weight to 17 parts by weight, and further preferably 5 parts by weight to 15 parts by weight, with respect to 100 parts by weight of the acetylcellulose derivative.

If the content of the plasticizer is 5 parts by weight to 20 parts by weight, the fluidity for performing the molding of the resin composition is easily obtained. In addition, the diameter of the plasticizer dispersed in the resin composition easily become small, and thus Charpy impact strength is easily controlled in the range of 11 kJ/m² or more. Moreover, the tensile strength and tensile elastic modulus of the obtained resin molded article are improved. Further, if the content of the plasticizer is 20 parts by weight or less, the bleeding of the plasticizer (precipitation phenomenon to the surface) is easily prevented.

In the case where the resin composition includes an acetylcellulose derivative and a plasticizer and does not include a polyolefin-containing multifunctional elastomer, if an acetylcellulose derivative having a low weight average molecular weight is used, Charpy impact strength is easily controlled in the range of 11 kJ/m² or more. In this case, the weight average molecular weight of the acetylcellulose derivative is preferably 40,000 to 120,000, and more preferably 40,000 to 100,000.

If the weight average molecular weight of the acetylcellulose derivative is within the above range, the diameter of the plasticizer dispersed at the time of mixing with the plasticizer easily becomes small, and thus the Charpy impact strength is easily controlled in the above range. As a result, the tensile strength and tensile elastic modulus of the obtained resin molded article are easily improved.

Contents of Acetylcellulose Derivative, Plasticizer and Polyolefin-Containing Multifunctional Elastomer

In the case where the resin composition according to the exemplary embodiment further includes a polyolefin-containing multifunctional elastomer, it is preferable that the resin composition includes an acetylcellulose derivative in an amount of 100 parts by weight, includes a plasticizer in an amount of 5 parts by weight to 20 parts by weight (preferably 5 parts by weight to 18 parts by weight, more preferably 5 parts by weight to 17 parts by weight, and further preferably 5 parts by weight to 15 parts by weight), and includes a polyolefin-containing multifunctional elastomer in an amount of 2 parts by weight to 10 parts by weight. That is, the content of the polyolefin-containing multifunctional elastomer is preferably 2 parts by weight to 10 parts by weight with respect to 100 parts by weight of the acetylcellulose derivative. The content of the polyolefin-containing multifunctional elastomer is more preferably 3 parts by weight to 8 parts by weight, and further preferably 4 parts by weight to 7 parts by weight.

If the content of the plasticizer is 5 parts by weight to 20 parts by weight and the content of the polyolefin-containing multifunctional elastomer is 2 parts by weight to 10 parts by weight, the fluidity for performing the molding of the resin composition is easily obtained. In addition, the diameter of the plasticizer dispersed at the time of mixing with the plasticizer easily becomes small. Further, if the content of the polyolefin-containing multifunctional elastomer is within the above range, the reaction site of an acetyl group or a hydroxyl group of the acetylcellulose derivative with an epoxy group or a glycidyl group becomes a sufficient state, and the space between molecules of the acetylcellulose derivative tends to be densely packed. As a result, Charpy impact strength is easily controlled in the range of 11 kJ/m² or more. In addition, the tensile strength and tensile elastic modulus of the obtained resin molded article is easily improved.

In the case where the resin composition includes an acetylcellulose derivative and a plasticizer and further includes a polyolefin-containing multifunctional elastomer, the weight average molecular weight of the acetylcellulose derivative is not particularly limited. In this case, if an acetylcellulose derivative having a weight average molecular weight of 40,000 to 300,000 is used, Charpy impact strength is easily controlled in the range of 11 kJ/m² or more.

In the resin composition according to the exemplary embodiment, even in any of the case where the resin composition includes an acetylcellulose derivative and a plasticizer and does not include a polyolefin-containing multifunctional elastomer and the case where the resin composition includes an acetylcellulose derivative, a plasticizer and a polyolefin-containing multifunctional elastomer, the weight percentage of the acetylcellulose derivative to the total resin composition may be 50% by weight or more, preferably 60% by weight or more, and more preferably 70% by weight or more. Further, the upper limit of the weight percentage of the acetylcellulose derivative to the total resin composition may be 96% by weight or less, preferably 95% by weight or less, and more preferably 94% by weight or less.

Physical Properties of Resin Composition

Charpy Impact Strength

The resin composition according to the exemplary embodiment is formed into a notched impact test piece by a method according to ISO179, and the notched Charpy impact strength of the notched impact test piece, measured at 23° C. by the method according to ISO179, is 11 kJ/m² or more. The Charpy impact strength is preferably 11.5 kJ/m² or more, and more preferably 12.0 kJ/m² or more. The upper limit of the Charpy impact strength is not particularly limited, but may be 20 kJ/m² or less because workability such as drilling is liable to deteriorate if the Charpy impact strength exceeds 20 kJ/m².

Tensile Strength and Tensile Elastic Modulus

A test piece is formed by a method according to ISO527, and the tensile strength and tensile elastic modulus of the test piece at 23° C. is measured by the method according to IS0527

The tensile strength may be 60 MPa or more, preferably 65 MPa or more, and more preferably 70 MPa or more. The upper limit thereof is not particularly limited, but may be 100 MPa or less in terms of productivity.

The tensile elastic modulus may be 2,500 MPa or more, preferably 2,700 MPa or more, and more preferably 2,800 MPa or more. Similarly to the tensile strength, the upper limit thereof is not particularly limited, but may be 5,000 MPa or less.

Diameter of Plasticizer Dispersed

The diameter of the plasticizer dispersed in the resin composition may be from 5 μm to 500 μm, and preferably from 50 μm to 200 μm, in terms of easily improving the tensile strength and tensile elastic modulus of the resin molded article.

The measurement of the diameter of the plasticizer dispersed is performed by the following method.

With respect to each of 10 grains of the resin composition pellets randomly taken out, an image of an electron microscope photograph is captured at an arbitrary portion thereof, and with respect to arbitrary 10 points each being present on each of the 10 images, measurement with a scale is performed to determine the diameter of the plasticizer dispersed.

The resin molded article formed using the resin composition having a Charpy impact strength of 11 kJ/m² or more and having tensile strength and tensile elastic modulus within the above range has high strength and unbreakable properties (difficult to break and difficult to deform). Therefore, for example, this resin composition is suitable as a resin composition for obtaining a resin molded article of applications requiring a shape having a large area and a thin thickness (for example, housings and the like of electronic and electric equipment and home electric appliances).

Other Components

The resin composition according to the exemplary embodiment, if necessary, may further include other components in addition to the above-described components. Examples of these other components include a flame retardant, a compatibilizer, a plasticizer, an antioxidant, a release agent, alight fasting agent, a weathering agent, a colorant, a pigment, a modifier, an anti-drip agent, an antistatic agent, an anti-hydrolyzing agent, a filler, and a reinforcing agent (glass fiber, carbon fiber, talc, clay, mica, glass flake, milled glass, glass bead, crystalline silica, alumina, silicon nitride, aluminum nitride, boron nitride, etc.).

Further, if necessary, components (additives), such as acid acceptor for preventing acetic acid release, a reactive trapping agent, and the like may be added. Examples of the acid acceptor include: oxides, such as magnesium oxide and aluminum oxide; metal hydroxides, such as magnesium hydroxide, calcium hydroxide, aluminum hydroxide, and hydrotalcite; calcium carbonate; and talc.

Examples of the reactive trapping agent include epoxy compounds, acid anhydride compounds, and carbodiimides.

The content of each of these components is preferably 0% by weight to 5% by weight with respect to the total resin composition. Here, the “0% by weight” means that the resin composition does not include these other components.

The resin composition according to the exemplary embodiment may include other resins other than the above-described resin. However, in the case where the resin composition includes these other resins, the weight percentage of these other resins may be 5% by weight or less, and preferably less than 1% by weight with respect to all the resins.

Examples of these other resins include conventionally known thermoplastic resins. Specific examples thereof include polycarbonate resins; polypropylene resins; polyester resins; polyolefin resins; polyester carbonate resins; polyphenylene ether resins, polyphenylene sulfide resins; polysulfone resins; polyether sulfone resins; polyarylene resins; polyether imide resins; polyacetal resins; polyvinyl acetal resins; polyketone resins; polyether ketone resins; polyether ether ketone resins; polyaryl ketone resins; polyether nitrile resins; liquid crystal resins; polybenzimidazole resins; polyparabanic acid resins; vinyl polymer or copolymers obtained by polymerizing or copolymerizing one or more vinyl monomers selected from the group consisting of aromatic alkenyl compounds, methacrylic acid esters, acrylic acid esters, and vinyl cyanide compounds; diene-aromatic alkenyl compound copolymers; vinyl cyanide-diene-aromatic alkenyl compound copolymers; aromatic alkenyl compound-diene-vinyl cyanide-N-phenyl maleimide copolymers; vinyl cyanide-(ethylene-diene-propylene (EPDM))-aromatic alkenyl compound copolymers; vinyl chloride resins; and chlorinated vinyl chloride resins. These resins may be used alone or in combination of two or more kinds thereof.

Method of Preparing Resin Composition

The resin composition according to the exemplary embodiment, for example, may be prepared by molten-kneading a mixture of the above-described components. In addition, the resin composition according to the exemplary embodiment, for example, may be prepared by dissolving the above-described components in a solvent. For molten-kneading, known machines maybe used, and specific examples thereof include a twin-screw extruder, a HENSCHEL MIXER, a BANBURY MIXER, a single-screw extruder, multi-screw extruder, and a co-kneader.

Resin Molded Article

The resin molded article according to the exemplary embodiment includes the resin composition according to the exemplary embodiment. That is, the resin molded article according to the exemplary embodiment is composed of the same composition as the resin composition according to the exemplary embodiment.

As the molding method of the resin molded article according to the exemplary embodiment, injection molding is preferable, in terms of a high degree of freedom in shape. In this regard, the resin molded article is preferably an injection molded article obtained by injection molding.

The cylinder temperature in injection molding is, for example, 200° C. to 300° C., and preferably 240° C. to 280° C. The mold temperature in injection molding is, for example, 40° C. to 90° C., and preferably 60° C. to 80° C. The injection molding may be performed using commercially available equipment, such as NEX 500 manufactured by NISSEI PLASTIC INDUSTRIAL CO., LTD., NEX 150 manufactured by NISSEI PLASTIC INDUSTRIAL CO., LTD., NEX 70000 manufactured by NISSEI PLASTIC INDUSTRIAL CO., LTD., PNX 40 manufactured by NISSEI PLASTIC INDUSTRIAL CO., LTD., or SE50D manufactured by TOSHIBA MACHINE CO., LTD.

The molding method for obtaining the resin molded article according to the exemplary embodiment is not limited to the above-described injection molding, and examples thereof include extrusion molding, blow molding, heat press molding, calendar molding, coating molding, cast molding, dipping molding, vacuum molding, and transfer molding.

The resin molded article according to the exemplary embodiment is suitably used for applications, such as electrical and electronic equipment, office equipment, household appliances, automobile interior materials, and containers. More specifically, this resin molded article is used for housings of electronic and electrical equipment and household appliances; various parts of electronic and electrical equipment and household appliances; interior parts of automobiles; storage cases of CD-ROM, DVD and the like; dishes; beverage bottles; food trays; wrapping material; films; and sheets.

### EXAMPLES

Hereinafter, the present invention will be described in more detail with reference to Examples, but the present invention is not limited to these Examples. Here, the “parts” represent “parts by weight” unless otherwise particularly specified.

Synthesis of Acetylcellulose Derivative

20 kg of cellulose (KC FLOCK W50, manufactured by NIPPON PAPER INDUSTURIES CO., LTD.) is put into 20 L of a 0.1 M aqueous hydrochloric acid solution, and heated and stirred at 40° C. to perform acid hydrolysis for 20 minutes.

1 kg of the resultant compound is sprayed with 5 kg of glacial acetic acid to perform activation as a pre-treatment. Then, a mixture of 38 kg of glacial acetic acid, 24 kg of acetic anhydride, and 350 g of sulfuric acid is added thereto, and mixed with stirring at a temperature of 40° C. or lower to perform esterification. When fiber pieces disappear, the esterification is completed, so as to obtain triacetylcellulose.

This triacetylcellulose is dropped into 200 L of distilled water, stirred at room temperature (25° C.) for 1 hour, filtered, and then dried at 60° C. for 72 hours.

After the drying, 20 kg of acetic acid, 10 kg of distilled water, and 800 g of hydrochloric acid are added thereto, and a reaction is performed at 40° C. for 5 hours. 5 kg of a reaction product is taken out, 300 g of calcium acetate is added to 5 kg of the reaction product, and the resultant product is stirred in 100 L of distilled water at room temperature (25° C.) for 2 hours, and filtered and dried at 60° C. for 72 hours, so as to obtain an acetylcellulose derivative (DAC1).

An acetylcellulose derivative (DAC2) is obtained in the same treatment as above, except that the reaction at 40° C. for 5 hours is changed to a reaction at 40° C. for 10 hours.

The weight average molecular weight and substitution degree of each of DAC1 and DAC2, measured by the above-described method, are shown in Table 1.

TABLE 1

| | Weight average molecular | |
|---|---|---|
| No. | weight (Mw) | Substitution degree |
| DAC1 | 61,000 | 2.58 |
| DAC2 | 135,000 | 1.95 |

### Examples 1 to 17 and Comparative Examples 1 to 8

Kneading

Each of the resin compositions having a composition ratio shown in Table 2 is kneaded by a biaxial kneading machine (TEX41SS, manufactured by TOSHIBA MACHINE CO., LTD.) with the cylinder temperature adjusted, so as to obtain a resin composition (pellets).

Injection molding The obtained pellets are molded into an ISO multipurpose dumbbell test piece (measuring portion dimension: width 10 mm/thickness 4 mm) using an injection molding machine (NEX 140III, manufactured by Nissei Plastic Industrial Co., Ltd.) at cylinder temperature shown in Table 3. In Comparative Examples 1 and 2, injection molding is impossible because poor plasticization is caused.

Evaluation 1

Charpy Impact Strength

The obtained ISO multipurpose dumbbell test piece is processed into a notched impact test piece by a method according to ISO179, and the notched impact strength of the notched impact test piece is measured at 23° C. using an impact strength measuring machine (CHN3 type CHARPY AUTO IMPACTOR TESTER, manufactured by Toyo Seiki Seisaku-Sho, Ltd.).

Measurement of Tensile Strength and Tensile Elastic Modulus

The tensile strength and tensile elastic modulus of the obtained ISO multipurpose dumbbell test piece are measured using a universal testing machine (AUTOGRAPH AG-Xplus, manufactured by Shimadzu Corporation) by a method according to ISO527.

TABLE 2

| | | | | | | | | | | | PO-containing | | | | | | |
|---|---|---|---|---|---|---|---|---|---|---|---|---|---|---|---|---|---|
| | | | | | | | | | | | multifunctional | | | | | | |
| | Acetylcellulose derivatives | | | | | | Plasticizers | | | | elastomer | | Other resins | | Other additives | | |
| | A | B | C | D | E | F | A | B | C | D | A | B | A | B | A | B | C |
| Example 1 | | | | 100 | | | 17 | | | | | | | | | | |
| Example 2 | | | 100 | | | | 17 | | | | 2 | | | | | | |
| Example 3 | 100 | | | | | | 15 | | | | 5 | | | | | | |
| Example 4 | 100 | | | | | | 12.5 | | | | 5 | | | | | | |
| Example 5 | 100 | | | | | | 5 | | | | 10 | | | | | | |
| Example 6 | 100 | | | | | | 15 | | | | | 5 | | | | | |
| Example 7 | | 100 | | | | | 8 | | | | 3 | | | | | | |
| Example 8 | 100 | | | | | | 15 | | | | 5 | | | | 0.5 | | |
| Example 9 | 100 | | | | | | 15 | | | | 5 | | | | 1 | | |
| Example 10 | 100 | | | | | | 15 | | | | 5 | | | | | 0.5 | |
| Example 11 | 100 | | | | | | 15 | | | | 5 | | | | | 1 | |
| Example 12 | | | | | 100 | | 15 | | | | 5 | | | | | | |
| Example 13 | | | | | | 100 | 15 | | | | 5 | | | | | | |
| Example 14 | 100 | | | | | | | 15 | | | 5 | | | | | | |
| Example 15 | | | | | | 100 | 18 | | | | 1 | | | | | | |
| Example 16 | | | | | | 100 | 20 | | | | 1 | | | | | | |
| Example 17 | | | 100 | | | | 17 | | | | | | | | | | |
| Comparative Example 1 | 100 | | | | | | 4 | | | | | | | | | | |
| Comparative Example 2 | 100 | | | | | | 4 | | | | 5 | | | | | | |
| Comparative Example 3 | 100 | | | | | | 25 | | | | | | | | | | |
| Comparative Example 4 | 100 | | | | | | | | 25 | | | | | | | | |
| Comparative Example 5 | 100 | | | | | | | | | 25 | | | 12.5 | | | | |
| Comparative Example 6 | 100 | | | | | | 15 | | | | | | | | | | 2 |
| Comparative Example 7 | 100 | | | | | | 15 | | | | | | 5 | | | | |
| Comparative Example 8 | 100 | | | | | | 15 | | | | | | | 1 | | | |

Material species in Table 2 are as follows.

Acetylcellulose Derivatives

Acetylcellulose derivative A: “L50”, manufactured by Daicel Corporation (weight average molecular weight: 161,000, substitution degree: 2.41)

Acetylcellulose derivative B: “L20”, manufactured by Daicel Corporation (weight average molecular weight: 119,000, substitution degree: 2.41)

Acetylcellulose derivative C: “CA-389-3”, manufactured by Eastman Chemical Company (weight average molecular weight: 79,500, substitution degree: 2.12)

Acetylcellulose derivative D: acetylcellulose derivative (DAC1) (weight average molecular weight: 61,000, substitution degree: 2.58)

Acetylcellulose derivative E: acetylcellulose derivative (DAC2) (weight average molecular weight: 135,000, substitution degree: 1.95)

Acetylcellulose derivative F: “LT-55”, manufactured by Daicel Corporation (weight average molecular weight: 198,000, substitution degree: 2.91)

Here, acetylcellulose derivatives (DAC1 and DAC2) are prepared by the above-described acetylcellulose derivative synthesis.

Plasticizer

Plasticizer A: “DAIFATTY-101”, manufactured by Daihachi Chemical Industry Co., Ltd. (adipic acid ester-containing compound)

Plasticizer B: “ADEKACIZER RS1000”, manufactured by ADEKA Corporation (polyether esters)

Plasticizer C: “DAR150”, manufactured by Daicel Corporation (triacetin)

Plasticizer D: “TPP”, manufactured by Daihachi Chemical Industry Co., Ltd. (triphenyl phosphate)

PO-Containing Multifunctional Elastomer (Polyolefin-Containing Multifunctional Elastomer)

PO-containing multifunctional elastomer A: “LOTARDER AX8900”, manufactured by ARKEMA Corporation (ethylene/methyl acrylate/glycidyl methacrylate copolymer, methyl acrylate, 24% by weight, glycidyl methacrylate 8% by weight)

PO-containing multifunctional elastomer B: “BONDFAST 7M”, manufactured by Sumitomo Chemical Co., Ltd. (Material name: ethylene/methyl acrylate/glycidyl methacrylate copolymer, methyl acrylate, 27% by weight, glycidyl methacrylate 6% by weight)

Other Resins

Resin A: “PARALOID EXL2602”, manufactured by Dow Chemical Company in Japan (core-shell type butadiene-methyl methacrylate copolymer)

Resin B: “Clarity LA2250”, manufactured by Kuraray Co., Ltd. (block copolymer of methyl methacrylate and butyl acrylate)

Other Additives

Additive A: “CARBODILITE (registered trademark) HMV-15CA”, manufactured by Nisshinbo Holdings, Inc. (carbodiimide)

Additive B: “SUTAMAGU PSF150”, manufactured by Konoshima Chemical Co., Ltd. (magnesium oxide)

Additive C: “DIPENTARITTO”, manufactured by Koei Chemical Co., Ltd. (dipentaerythritol)

TABLE 3

| | | Resin molded article | | |
|---|---|---|---|---|
| | Injection molding | Charpy | | Tensile |
| | Cylinder | impact | Tensile | elastic |
| | temperature | strength | strength | modulus |
| | ° C. | kJ/m² | MPa | MPa |
| Example 1 | 250 | 15.8 | 70 | 2,800 |
| Example 2 | 250 | 13.9 | 71 | 2,900 |
| Example 3 | 240 | 12.1 | 70 | 2,850 |
| Example 4 | 240 | 11.2 | 81 | 3,100 |
| Example 5 | 240 | 12.5 | 85 | 3,450 |
| Example 6 | 240 | 11.3 | 70 | 2,800 |
| Example 7 | 240 | 11.8 | 90 | 3,600 |
| Example 8 | 240 | 11.2 | 72 | 2,850 |
| Example 9 | 240 | 11.5 | 72 | 2,700 |
| Example 10 | 240 | 11.2 | 74 | 3,000 |
| Example 11 | 240 | 11.2 | 80 | 3,050 |
| Example 12 | 250 | 11.1 | 65 | 2,600 |
| Example 13 | 280 | 11.9 | 68 | 2,600 |
| Example 14 | 240 | 11.5 | 65 | 2,600 |
| Example 15 | 230 | 13.5 | 63 | 2,500 |
| Example 16 | 220 | 14.8 | 62 | 2,400 |
| Example 17 | 230 | 15.2 | 70 | 2,800 |
| Comparative | Injection molding impossible | | | |
| Example 1 | | | | |
| Comparative | Injection molding impossible | | | |
| Example 2 | | | | |
| Comparative | 220 | 10.7 | 44 | 1,950 |
| Example 3 | | | | |
| Comparative | 220 | 5.4 | 55 | 2,200 |
| Example 4 | | | | |
| Comparative | 220 | 6.2 | 55 | 2,350 |
| Example 5 | | | | |
| Comparative | 220 | 4.8 | 45 | 2,000 |
| Example 6 | | | | |
| Comparative | 220 | 8.5 | 40 | 1,950 |
| Example 7 | | | | |
| Comparative | 220 | 9 | 42 | 2,010 |
| Example 8 | | | | |

From the above results, it is understood that the evaluation results of Charpy impact strength in Examples are good compared to those in Comparative Examples, and the evaluation results of tensile strength and tensile elastic modulus in Examples are good compared to those in Comparative Examples.

Evaluation 2

Observation of Diameter of Plasticizer Dispersed

The diameter of plasticizer dispersed is measured by the above-described measuring method.

TABLE 4

| | Diameter of plasticizer dispersed |
|---|---|
| | (μm) |
| Example 1 | 120 |
| Example 2 | 150 |
| Example 3 | 250 |
| Example 4 | 65 |
| Example 5 | 105 |
| Example 6 | 380 |
| Example 7 | 255 |
| Example 8 | 118 |
| Example 9 | 35 |
| Example 10 | 358 |
| Example 11 | 218 |
| Example 12 | 115 |
| Example 13 | 100 |
| Example 14 | 230 |
| Example 15 | 25 |
| Example 16 | 10 |
| Example 17 | 485 |
| Comparative Example 1 | 1500 |
| Comparative Example 2 | 1250 |
| Comparative Example 3 | 785 |
| Comparative Example 4 | 1050 |
| Comparative Example 5 | 698 |
| Comparative Example 6 | 852 |
| Comparative Example 7 | 550 |
| Comparative Example 8 | 575 |

From the above results, it is understood that the diameter of the plasticizer dispersed provided in Examples are smaller than those provided in Comparative Examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A resin composition, comprising:
100 parts by weight of a cellulose derivative in which at least one hydroxyl group of cellulose is substituted with an acetyl group; and
from 5 parts by weight to 20 parts by weight of a non-reactive plasticizer which does not have a functional group capable of reacting with the cellulose derivative,
wherein a notched impact test piece formed from the resin composition by a method according to ISO179 exhibits a notched Charpy impact strength as measured at 23° C. by the method according to ISO179, of 11 kJ/m² or more.

2. The resin composition according to claim 1, wherein the notched impact test piece formed from the resin composition by a method according to ISO179 exhibits a notched Charpy impact strength, as measured at 23° C. by the method according to ISO179, of 11 kJ/m² to 20 kJ/m².

3. The resin composition according to claim 1, wherein the plasticizer is a compound containing an adipic acid ester.

4. The resin composition according to claim 1, wherein the resin composition includes the plasticizer in an amount of 5 parts by weight to 15 parts by weight with respect to 100 parts by weight of the cellulose derivative.

5. The resin composition according to claim 1, wherein the substitution degree of the acetyl group in the cellulose derivative is from 2.1 to 2.6.

6. The resin composition according to claim 1, further comprising a polyolefin-containing multifunctional elastomer containing a polyolefin as a main component and having a functional group including at least one selected from an epoxy group and a glycidyl group.

7. The resin composition according to claim 1, wherein the resin composition includes the polyolefin-containing multifunctional elastomer in an amount of 2 parts by weight to 10 parts by weight with respect to 100 parts by weight of the cellulose derivative.

8. The resin composition according to claim 6, wherein the polyolefin-containing multifunctional elastomer is a compound represented by the formula (3) below: 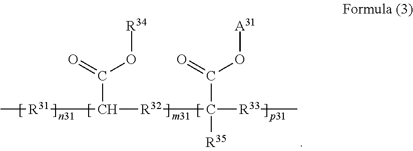
wherein R³¹ represents a linear alkylene group having 2 to 6 carbon atoms, R³² and R³³ each independently represents a linear alkylene group having 1 to 6 carbon atoms, R³⁴ and R³⁵ each independently represents a linear or branched alkyl group having 1 to 4 carbon atoms, A³¹ represents an epoxy group or a glycidyl group, n31 represents an integer of 50 to 100, and m31 and p31 each independently represents an integer of 1 to 50.

9. The resin composition according to claim 1, wherein the weight percentage of the cellulose derivative is 50% by weight or more with respect to the total amount of the resin composition.

10. A resin molded article, comprising:
100 parts by weight of a cellulose derivative in which at least one hydroxyl group of cellulose is substituted with an acetyl group; and
from 5 parts by weight to 20 parts by weight of a non-reactive plasticizer which does not have a functional group capable of reacting with the cellulose derivative,
wherein a notched impact test piece formed from the resin composition by a method according to ISO179 exhibits a notched Charpy impact strength as measured at 23° C. by the method according to ISO179, of 11 kJ/m² or more.

11. The resin molded article according to claim 10, wherein the notched impact test piece formed from the resin composition by a method according to ISO179 exhibits a notched Charpy impact strength as measured at 23° C. by the method according to ISO179, of 11 kJ/m² to 20 kJ/m².

12. The resin molded article according to claim 10, wherein the plasticizer is a compound containing an adipic acid ester.

13. The resin molded article according to claim 10, wherein the resin molded article includes the plasticizer in an amount of 5 parts by weight to 15 parts by weight with respect to 100 parts by weight of the cellulose derivative.

14. The resin molded article according to claim 10, wherein the substitution degree of the acetyl group in the cellulose derivative is from 2.1 to 2.6.

15. The resin molded article according to claim 10, further comprising a polyolefin-containing multifunctional elastomer containing a polyolefin as a main component and having a functional group including at least one selected from an epoxy group and a glycidyl group.

16. The resin molded article according to claim 10, wherein the resin molded article includes the polyolefin-containing multifunctional elastomer in an amount of 2 parts by weight to 10 parts by weight with respect to 100 parts by weight of the cellulose derivative.

17. The resin molded article according to claim 15, wherein the polyolefin-containing multifunctional elastomer is a compound represented by the formula (3) below: 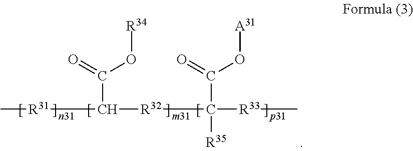
wherein R³¹ represents a linear alkylene group having 2 to 6 carbon atoms, R³² and R³³ each independently represents a linear alkylene group having 1 to 6 carbon atoms, R³⁴ and R³⁵ each independently represents a linear or branched alkyl group having 1 to 4 carbon atoms, A³¹ represents an epoxy group or a glycidyl group, n31 represents an integer of 50 to 100, and m31 and p31 each independently represents an integer of 1 to 50.

18. The resin molded article according to claim 10, wherein the weight percentage of the cellulose derivative is 50% by weight or more with respect to the total amount of the resin molded article.

19. The resin molded article according to claim 10, wherein the resin molded article is an injection-molded article.
